(19) United States
(12) Patent Application Publication
(10) Pub. No.: US 2026/0094056 A1
(43) Pub. Date: Apr. 2, 2026

(54) EFFICIENCY AND FLEXIBILITY OF MACHINE LEARNING MODELS

(71) Applicant: Lemon Inc., Grand Cayman (KY)

(72) Inventors: Chia-Wen Kuo, Los Angeles, CA (US); Sijie Zhu, Los Angeles, CA (US); Fan Chen, Los Angeles, CA (US); Longyin Wen, Los Angeles, CA (US)

(21) Appl. No.: 18/902,837

(22) Filed: Sep. 30, 2024

(51) Int. Cl. G06N 20/00

(52) U.S. Cl. CPC G06N 20/00

(57) ABSTRACT

The present disclosure describes techniques for improving efficiency and flexibility of a machine learning model. A machine learning model is configured to decompose self-attention in the machine learning model into a plurality of attention operations. The machine learning model is configured to process information from a plurality of modalities. Concatenated tokens are received by the machine learning model. The concatenated tokens comprise multimodal tokens representative of a content item and textual tokens indicative of a text query. Updated multimodal tokens for a next layer of computation are generated by performing diagonal-attention on the multimodal tokens. Updated textual tokens for the next layer of computation are generated by performing self-attention on the textual tokens and performing cross-attention between the multimodal tokens and the textual tokens.

### BACKGROUND

Machine learning models are increasingly being used across a variety of industries to perform a variety of different tasks. Such tasks may include generating descriptions of content. Improved techniques for utilizing machine learning models for content description generation are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for improving efficiency and flexibility of a machine learning model in accordance with the present disclosure.

FIG. 2 shows an example system for decomposed self-attention in accordance with the present disclosure.

FIG. 3 shows an example system for improving efficiency and flexibility of a machine learning model in accordance with the present disclosure.

FIG. 4 shows an example process for improving efficiency and flexibility of a machine learning model in accordance with the present disclosure.

FIG. 5 shows an example process for improving efficiency and flexibility of a machine learning model in accordance with the present disclosure.

FIG. 6 shows an example process for improving efficiency and flexibility of a machine learning model in accordance with the present disclosure.

FIG. 7 shows an example process for improving efficiency and flexibility of a machine learning model in accordance with the present disclosure.

FIG. 8 shows an example process for improving efficiency and flexibility of a machine learning model in accordance with the present disclosure.

FIG. 9 shows an example process for improving efficiency and flexibility of a machine learning model in accordance with the present disclosure.

FIG. 10 shows an example table illustrating performance data in accordance with the present disclosure.

FIG. 11 shows an example computing device which may be used to perform any of the techniques disclosed herein.

### DETAILED DESCRIPTION OF ILLUSTRATIVE EMBODIMENTS

Large vision language models (e.g., multi-modal large language models) have achieved significant success in a variety of different applications requiring multi-modal inputs, such as images, videos, audio, speech, etc. Such models are typically composed of three components: a multi-modal encoder configured to encode multi-modal inputs into a sequence of multi-modal embedding tokens, a projector configured to project encoded multi-modal embedding tokens into a text embedding space of a large language model, and a large language model configured to receive an input sequence of concatenated projected multi-modal tokens and text tokens for generating text output.

However, the naive concatenation of multi-modal tokens and text tokens for input into the large language model, while simple, is associated with various drawbacks. For example, the naive concatenation of multi-modal tokens and text tokens for input into the large language model is associated with a low computational efficiency. The processing of the concatenated multi-modal tokens and text tokens may be computationally expensive due to the quadratic computational complexity of the large language model with respect to the length of input tokens. Further, the naive concatenation of multi-modal tokens and text tokens for input into the large language model leads to a lack of flexibility. Multi-modal input tokens are treated and modeled the same way as text tokens, which may be suboptimal and lack flexibility. These potential drawbacks are magnified when applying the large language model to applications with a longer sequence of multi-modal tokens, such as multi-modal tokens representative of high-resolution images or videos with multiple image frames, and/or to applications with more modalities that require dedicated processing of each modality (e.g., videos with images, speech, and audio modalities). As such, techniques for improving efficiency and flexibility of machine learning models are needed.

Described herein are improved techniques for improving efficiency and flexibility of machine learning models. Described herein is a machine learning model having a novel decomposed attention mechanism to tackle the lack of flexibility and high computational complexity issues associated with existing machine learning models. The decomposed attention mechanism decomposes self-attention in a large language model into three parts: a multimodal-to-multimodal diagonal-attention configured to reduce computational complexity from O(n²) to O(n), a text-to-multimodal cross-attention that enables flexible processing for each modality, and text-to-text self-attention that enables the machine learning model to maintain the original text processing power of the large language model. The decomposed attention mechanism significantly reduces computational complexity while maintaining comparable model performance.

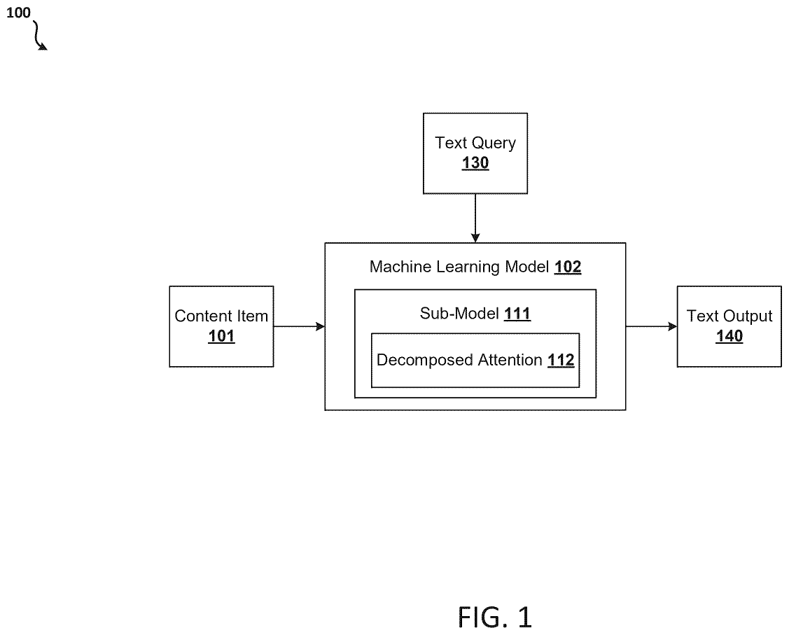

FIG. 1 illustrates an example system 100 in accordance with the present disclosure. The system 100 can include a machine learning model 102. The machine learning model 102 can be configured to process information from a plurality of modalities. The plurality of modalities can include images, videos, audio, speech, and/or the like. The machine learning model 102 can include, for example, a large vision language models (e.g., multi-modal large language model). The machine learning model 102 can include a multi-modal encoder configured to encode multi-modal inputs into a sequence of multi-modal embedding tokens, a projector configured to project encoded multi-modal embedding tokens into a latent input space (e.g., text embedding space) of a large language model, and a sub-model 111 (e.g., the large language model) configured to receive an input sequence of concatenated projected multi-modal tokens and text tokens for generating text output.

The sub-model 111 can include a decomposed attention mechanism 112. The decomposed attention mechanism 112 can include a plurality of attention operations. The plurality of attention operations can include a multimodal-to-multimodal diagonal-attention. The multimodal-to-multimodal can be configured to reduce computational complexity. The plurality of attention operations can include a text-to-multimodal cross-attention. The text-to-multimodal cross-attention can enable flexible processing for each modality. The plurality of attention operations can include a text-to-text self-attention. The text-to-text self-attention can enable the machine learning model to maintain the original text processing power of a large language model that does not include a decomposed attention mechanism.

The machine learning model 102 can receive, as input, a content item 101 and a text query 130. The text query 130 can include a query indicating a question to be answered about the content item 101 and/or any other natural language task to be performed with respect to the content item 101. The machine learning model 102 can generate multimodal tokens based on the content item 101. The machine learning model 102 can include an encoder (e.g., a Contrastive Language-Image Pre-Training (CLIP) encoder). The encoder can be configured to generate the multimodal tokens based on the content item. The machine learning model 102 can generate textual tokens based on the text query 130. For example, the machine learning model 102 can generate a set of textual tokens representative of the text query 130. The machine learning model 102 can generate the textual tokens using any suitable technique, such as by using one or more text encoders. The multimodal tokens can be projected into a latent input space (e.g., text embedding space) of the sub-model 111. The projected multimodal tokens and the textual tokens can be concatenated. The concatenated tokens can be input into the sub-model 111.

The machine learning model 102 can generate text output 140. The machine learning model 102 can generate the text output 140 based on the concatenated tokens. The text output 140 can include a text description of the content item 101. The text description 140 of the content item 101 can be responsive to the text query 130. The sub-model 111 can include a plurality of layers of computation. To generate the text output 140, the sub-model 111 can generate updated multimodal tokens for a next layer of computation. The sub-model 111 can generate updated multimodal tokens by performing diagonal-attention on the multimodal tokens. For example, the sub-model 111 can perform the diagonal-attention based on comparing each of the multimodal tokens to itself but not to any other multimodal token among the plurality of multimodal tokens.

The sub-model 111 can generate updated textual tokens for the next layer of computation by performing self-attention on the textual tokens and by performing cross-attention between the multimodal tokens and the textual tokens. For example, the sub-model 111 can generate the updated textual tokens based in part on generating a set of cross-attention tokens. The sub-model 111 can generate the set of cross-attention tokens by performing the cross-attention between the multimodal tokens and the textual tokens. The sub-model 111 can generate a set of text self-attention tokens by performing the self-attention on the textual tokens. The updated textual tokens can be generated based on the set of cross-attention tokens and the set of text self-attention tokens. For example, the updated textual tokens can be generated based on calculating a weighted sum of the set of cross-attention tokens and the set of text self-attention tokens. The updated multimodal tokens and the updated textual tokens can be utilized for the next layer of computation by the sub-model 111. The text output 140 can be generated based on the output of the last layer of computation of the sub-model 111.

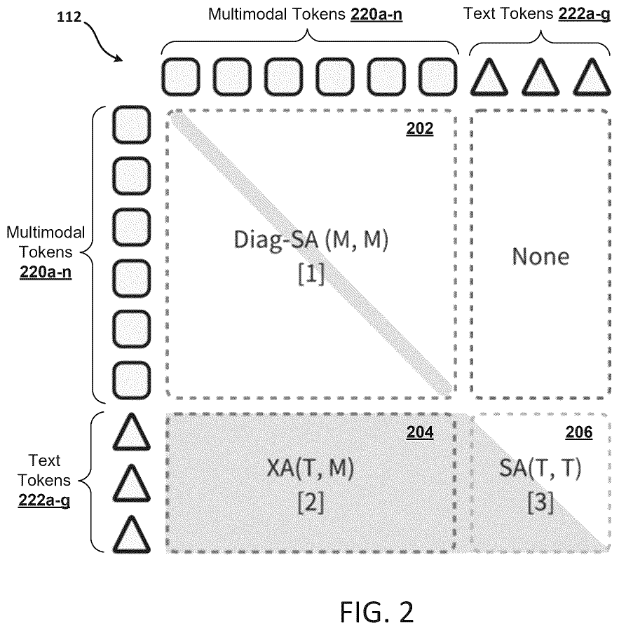

FIG. 2 illustrates an example decomposed attention mechanism 112 of the sub-model 111. The decomposed attention mechanism 112 includes three attention operations: a multimodal-to-multimodal diagonal-attention 202 (i.e., Diag-SA (M, M)), a text-to-multimodal cross-attention 204 (i.e., XA (T, M)), and a text-to-text self-attention 206 (i.e., SA (T,T)). As described above, the sub-model 111 can receive concatenated tokens. The concatenated tokens can include a plurality of multimodal tokens 220a-n. The plurality of multimodal tokens 220a-n can be representative of any type of content item, including an image, a video, or an audio item. The concatenated tokens can also include a plurality of textual tokens 222a-g.

The multimodal-to-multimodal diagonal-attention 202 can generate updated multimodal tokens for a next layer of computation in the sub-model 111. The multimodal-to-multimodal diagonal-attention 202 can generate the updated multimodal tokens by performing diagonal-attention on the plurality of multimodal tokens 220a-n. The multimodal-to-multimodal diagonal-attention 202 can perform the diagonal-attention based on comparing each multimodal tokens among the plurality of multimodal tokens 220a-n to itself but not to any other multimodal token among the plurality of multimodal tokens 220a-n. For example, the multimodal-to-multimodal diagonal-attention 202 can perform the diagonal-attention based on comparing the multimodal token 220a to only the multimodal token 220a, the multimodal token 220b to only the multimodal token 220b, the multimodal token 220c to only the multimodal token 220c, and so on. Implementing the multimodal-to-multimodal diagonal-attention 202 can reduce computational complexity, as each multimodal token among the plurality of multimodal tokens 220a-n only needs to be compared to itself—and not or to any other multimodal token among the plurality of multimodal tokens 220a-n.

The text-to-multimodal cross-attention 204 can generate a set of cross-attention tokens by performing cross-attention between the plurality of multimodal tokens 220a-n and the plurality of textual tokens 222a-g. The text-to-multimodal cross-attention 204 enables flexible processing for each of the plurality of modalities by performing cross-attention between the plurality of multimodal tokens 220a-n and the plurality of textual tokens 222a-g. The text-to-text self-attention 206 can generate a set of text self-attention tokens by performing self-attention on the plurality of textual tokens 222a-g. The text-to-text self-attention 206 can maintain the original text processing power of a large language model that does not include the decomposed attention mechanism 112. Updated textual tokens for the next layer of computation can be generated based on the set of cross-attention tokens and the set of text self-attention tokens. Generating the updated textual tokens for the next layer of computation can include generating the updated textual tokens based on a first weight associated with the set of cross-attention tokens and a second weight associated with the set of text self-attention tokens.

The text-to-multimodal cross-attention 204 (i.e., XA(T, M)) and the text-to-text self-attention 206 (i.e., SA(T, T)) can be the decomposition of attention XA(T, [M, T]) comprising cross-attention between the multi-modal tokens and the textual tokens as well as the self-attention of the textual tokens by the following formula:

$$\begin{matrix}XA ( T , [ M , T ] ) = {\sum }_{i} \frac{{q}_{t} \cdot {k}_{i}}{{\sum }_{l} {e}^{{q}_{t} \cdot {k}_{i}}} {v}_{i} \\ = {\sum }_{i} \frac{{q}_{t} \cdot {k}_{T , i}}{{\sum }_{l} {e}^{{q}_{t} \cdot {k}_{l}}} {v}_{T , i} + {\sum }_{j} \frac{{q}_{t} \cdot {k}_{M , j}}{{\sum }_{l} {e}^{{q}_{t \cdot {k}_{l}}}} {v}_{M , j} \\ = \frac{{\sum }_{m} {e}^{{q}_{t} \cdot {k}_{T , m}}}{{\sum }_{l} {e}^{{q}_{t} \cdot {k}_{l}}} {\sum }_{i} \frac{{q}_{t} \cdot {k}_{T , i}}{{\sum }_{m} {e}^{{q}_{t} \cdot {k}_{T , m}}} {v}_{T , i} + \\ \frac{{\sum }_{m} {e}^{{q}_{t} \cdot {k}_{M , m}}}{{\sum }_{l} {e}^{{q}_{t} \cdot {k}_{l}}} {\sum }_{j} \frac{{q}_{t} \cdot {k}_{M , j}}{{\sum }_{m} {e}^{{q}_{t \cdot {k}_{M , m}}}} {v}_{M , i} \\ = \frac{{\sum }_{m} {e}^{{q}_{t} \cdot {k}_{T , m}}}{{\sum }_{l} {e}^{{q}_{t} \cdot {k}_{l}}} SA ( T , T ) + \\ \frac{{\sum }_{m} {e}^{{q}_{t} \cdot {k}_{M , m}}}{{\sum }_{l} {e}^{{q}_{t} \cdot {k}_{l}}} XA ( T , M )\end{matrix}$$

where α_{T} represents a weight assigned to the text-to-text self-attention 206 and α_{I} represents a weight assigned to the text-to-multimodal cross-attention 204. According to this formula, α_{T} and α_{I} can each have a value such that the text-to-multimodal cross-attention 204 (i.e., XA(T, M)) and the text-to-text self-attention 206 (i.e., SA(T, T)) are equal to, or substantially equal to, the attention XA(T, [M, T]). In other embodiments, α_{T} and/or α_{I} can be adjusted manually to customize the machine learning model 102, thereby improving the flexibility of the machine learning model 102.

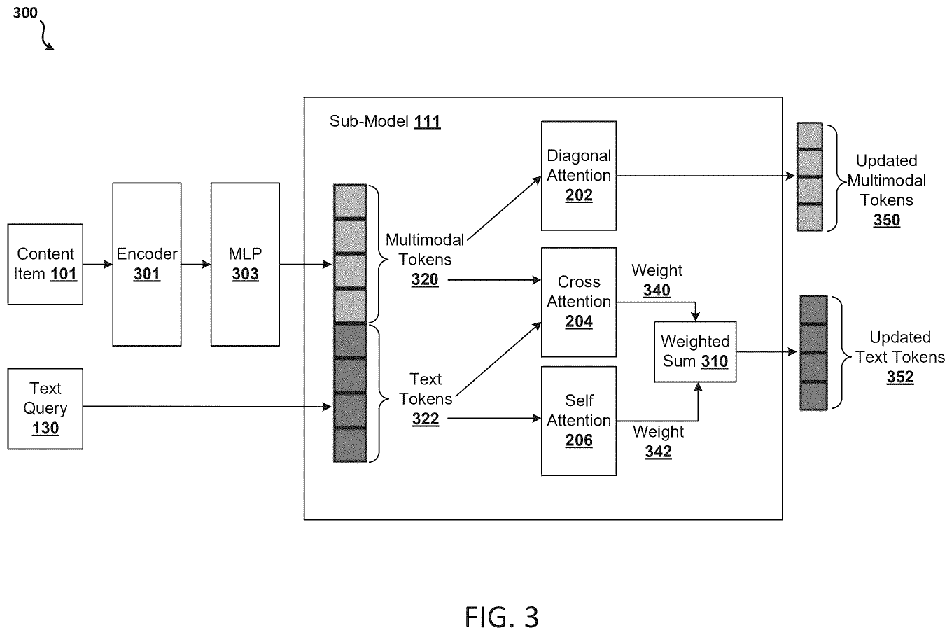

FIG. 3 illustrates an example system 300 in accordance with the present disclosure. The system 300 can include the machine learning model 102. The machine learning model 102 can include an encoder 301, a MLP 303, and the sub-model 111.

The machine learning model 102 can receive, as input, the content item 101 and the text query 130. The text query 130 can include a query indicating a question to be answered about the content item 101 and/or any other natural language task to be performed with respect to the content item 101. The encoder 301 can generate multi-modal embeddings based on the content item 101. The encoder 301 can include, for example, a CLIP encoder. The machine learning model 102 can generate textual tokens 322 based on the text query 130. For example, the machine learning model 102 can generate a set of textual tokens 322 representative of the text query 130. The machine learning model 102 can generate the textual tokens 322 using any suitable technique, such as by using one or more text encoders. The MLP 303 can project the multi-modal embeddings into an input space of the sub-model 111 to generate the multimodal tokens 320. For example, the MLP 303 can generate the multimodal tokens 320 that align with the textual tokens 322. The multimodal tokens 320 and the textual tokens 322 can be concatenated and can be input into the sub-model 111.

The sub-model 111 can be configured to decompose self-attention of the concatenated tokens into a plurality of attention operations. The plurality of attention operations comprise the multimodal-to-multimodal diagonal-attention 202. The multimodal-to-multimodal diagonal-attention 202 can generate updated multimodal tokens 350 for a next layer of computation in the sub-model 111. The multimodal-to-multimodal diagonal-attention 202 can generate the updated multimodal tokens 350 by performing diagonal-attention on the multimodal tokens 320. The multimodal-to-multimodal diagonal-attention 202 can perform the diagonal-attention based on comparing each of the multimodal tokens 320 to itself but not to any other multimodal token. Implementing the multimodal-to-multimodal diagonal-attention 202 can reduce computational complexity, as each of the multimodal tokens 320 only needs to be compared to itself—and not to any of the textual tokens 322 or to any other multimodal token.

The plurality of attention operations further comprise the text-to-multimodal cross-attention 204. The text-to-multimodal cross-attention 204 can generate a set of cross-attention tokens by performing cross-attention between the multimodal tokens 320 and the textual tokens 322. The plurality of attention operations further comprise the text-to-text self-attention 206. The text-to-text self-attention 206 can generate a set of text self-attention tokens by performing self-attention on the textual tokens 322. Updated textual tokens 352 for the next layer of computation can be generated based on the set of cross-attention tokens and the set of text self-attention tokens. Generating the updated textual tokens 352 for the next layer of computation can include generating the updated textual tokens based on a weight, α_{I}, associated with the set of cross-attention tokens and a weight, α_{T}, associated with the set of text self-attention tokens. As described above, the value of the weight a, and the value of the weight α_{T} can be configured to maintain original text processing power of the large language model prior to the attention decomposition. Alternatively, the value of the weight a, and the value of the weight α_{T} can be manually adjusted to customize performance of the machine learning model 102.

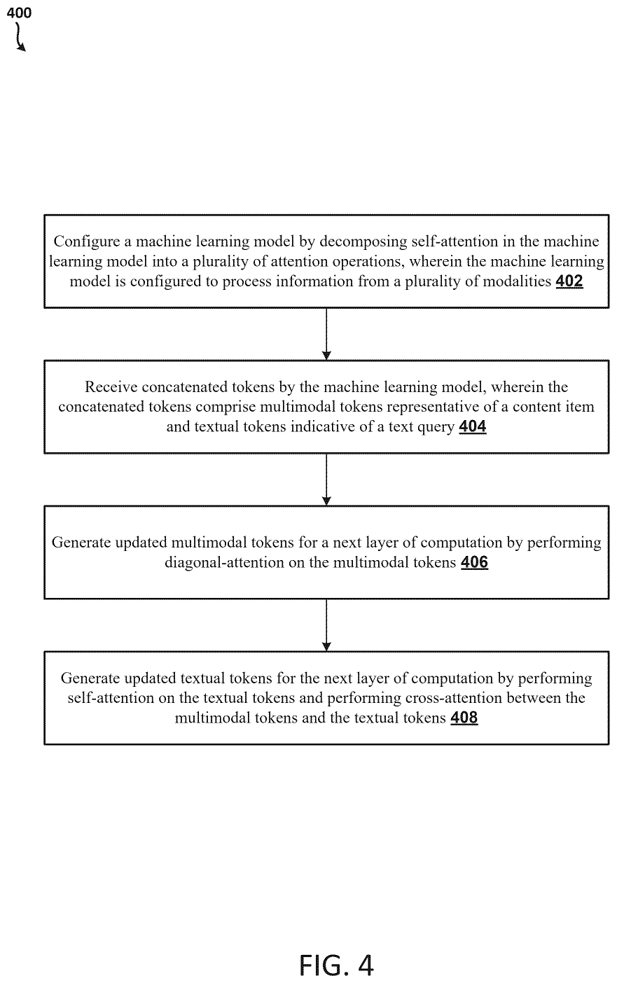

FIG. 4 shows an example process 400 for improving efficiency and flexibility of a machine learning model. Although depicted as a sequence of operations in FIG. 4, those of ordinary skill in the art will appreciate that various embodiments may add, remove, reorder, or modify the depicted operations.

At 402, a machine learning model (e.g., the sub-model 111) can be configured. The machine learning model can be configured by decomposing self-attention in the machine learning model into a plurality of attention operations (e.g., utilizing decomposed attention mechanism 112). The plurality of attention operations can include a multimodal-to-multimodal diagonal-attention (e.g., the multimodal-to-multimodal diagonal-attention 202) configured to reduce computational complexity. The plurality of attention operations can include a text-to-multimodal cross-attention (e.g., the text-to-multimodal cross-attention 204) that enables flexible processing for each modality. The plurality of attention operations can include a text-to-text self-attention (e.g., the text-to-text self-attention 206) that enables the machine learning model to maintain the original text processing power of a large language model that does not include a decomposed attention mechanism. The machine learning model can be configured to process information from a plurality of modalities. The plurality of modalities can include one or more of images, videos, and/or audio content.

At 404, concatenated tokens can be received by the machine learning model. The concatenated tokens can include multimodal tokens (e.g., the plurality of multimodal tokens 220a-n). The multimodal tokens can be representative of a content item (e.g., content item 101). The content item can include one or more images, video(s), or audio content items. The concatenated tokens can include textual tokens (e.g., the plurality of textual tokens 222a-g). The textual tokens can be indicative of a text query (e.g., the text query 130).

At 406, updated multimodal tokens (e.g., updated multimodal tokens 350) can be generated. The updated multimodal tokens can be used for a next layer of computation. The updated multimodal tokens can be generated by performing diagonal-attention on the multimodal tokens. At 408, updated textual tokens (e.g., updated textual tokens 352) can be generated. The updated textual tokens can be generated for the next layer of computation. The updated textual tokens can be generated by performing self-attention on the textual tokens. The updated textual tokens can be generated by performing cross-attention between the multimodal tokens and the textual tokens. The updated multimodal tokens and the updated textual tokens can be used for the next layer of computation by the machine learning model. This process can be repeated until each layer of computation is complete. The output of the last layer of computation can be used to generate a text description (e.g., text description 140) of the content item. The text description can be responsive to the text query.

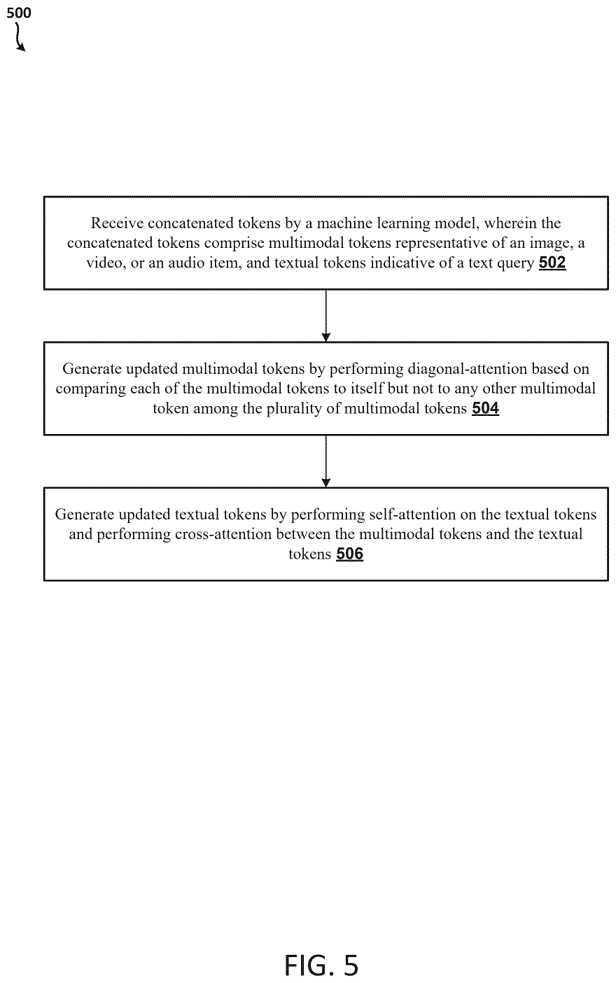

FIG. 5 shows an example process 500 for improving efficiency and flexibility of a machine learning model. Although depicted as a sequence of operations in FIG. 5, those of ordinary skill in the art will appreciate that various embodiments may add, remove, reorder, or modify the depicted operations.

At 502, concatenated tokens can be received by a machine learning model (e.g., the machine learning model 102). The concatenated tokens can include multimodal tokens (e.g., the plurality of multimodal tokens 220a-n). The multimodal tokens can be representative of a content item (e.g., content item 101). The content item can include one or more images, video(s), or audio content items. The concatenated tokens can include textual tokens (e.g., the plurality of textual tokens 222a-g). The textual tokens can be indicative of a text query (e.g., the text query 130).

At 504, updated multimodal tokens (e.g., updated multimodal tokens 350) can be generated. The updated multimodal tokens can be used for a next layer of computation. The updated multimodal tokens can be generated by performing diagonal-attention on the multimodal tokens. The updated multimodal tokens can be generated by comparing each of the multimodal tokens to itself but not to any other multimodal token among the plurality of multimodal tokens. At 506, updated textual tokens (e.g., updated textual tokens 352) can be generated. The updated textual tokens can be generated for the next layer of computation. The updated textual tokens can be generated by performing self-attention on the textual tokens. The updated textual tokens can be generated by performing cross-attention between the multimodal tokens and the textual tokens. The updated multimodal tokens and the updated textual tokens can be fed back into the machine learning model for the next layer of computation. This process can be repeated until each layer of computation is complete. The output of the last layer of computation can be used to generate a text description (e.g., text description 140) of the content item. The text description can be responsive to the text query.

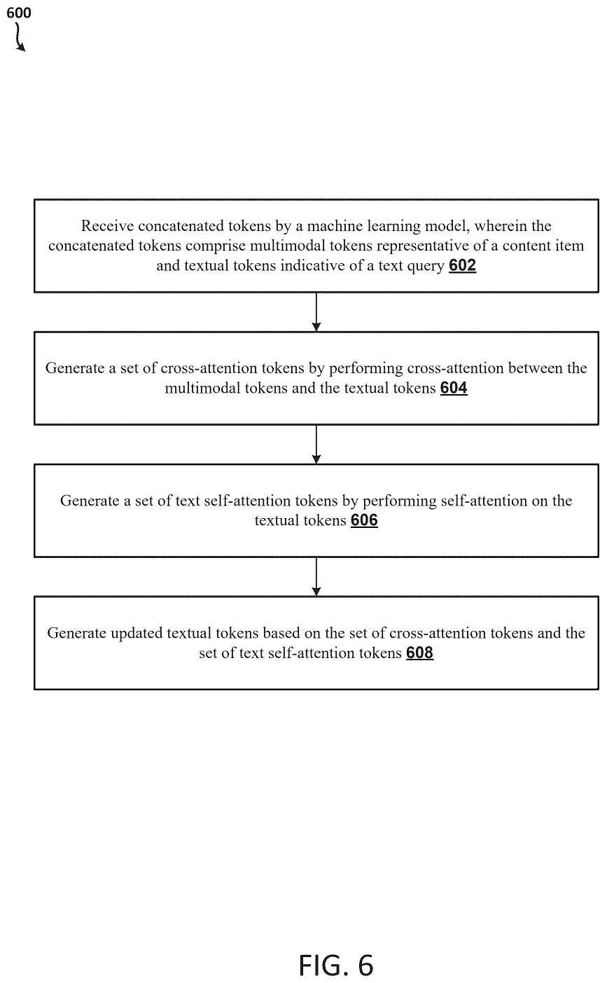

FIG. 6 shows an example process 600 for improving efficiency and flexibility of a machine learning model. Although depicted as a sequence of operations in FIG. 6, those of ordinary skill in the art will appreciate that various embodiments may add, remove, reorder, or modify the depicted operations.

At 602, concatenated tokens can be received by a machine learning model (e.g., the machine learning model 102). The concatenated tokens can include multimodal tokens (e.g., the plurality of multimodal tokens 220a-n). The multimodal tokens can be representative of a content item (e.g., content item 101). The content item can include one or more images, video(s), or audio content items. The concatenated tokens can include textual tokens (e.g., the plurality of textual tokens 222a-g). The textual tokens can be indicative of a text query (e.g., the text query 130).

At 604, a set of cross-attention tokens can be generated. The set of cross-attention tokens can be generated by performing cross-attention between the multimodal tokens and the textual tokens. At 606, a set of text self-attention tokens can be generated. The set of text self-attention tokens can be generated by performing self-attention on the textual tokens. At 608, updated textual tokens (e.g., updated textual tokens 352) can be generated. The updated textual tokens can be generated for a next layer of computation. The updated textual tokens can be generated based on the set of cross-attention tokens and the set of text self-attention tokens. The updated multimodal tokens and the updated textual tokens can be fed back into the machine learning model for the next layer of computation. This process can be repeated until each layer of computation is complete. The output of the last layer of computation can be used to generate a text description (e.g., text description 140) of the content item. The text description can be responsive to the text query.

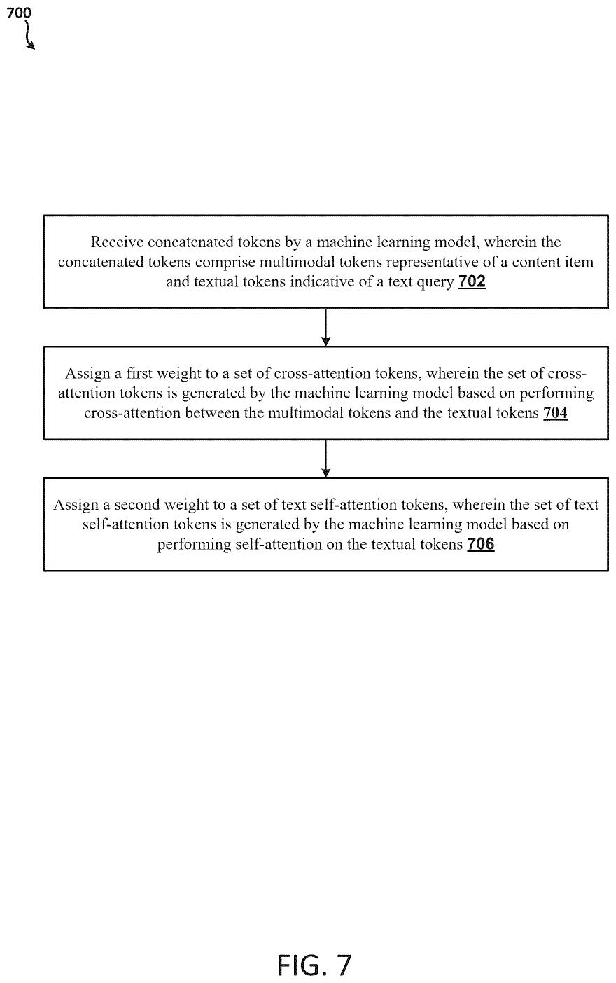

FIG. 7 shows an example process 700 for improving efficiency and flexibility of a machine learning model. Although depicted as a sequence of operations in FIG. 7, those of ordinary skill in the art will appreciate that various embodiments may add, remove, reorder, or modify the depicted operations.

At 702, concatenated tokens can be received by a machine learning model (e.g., the machine learning model 102). The concatenated tokens can include multimodal tokens (e.g., the plurality of multimodal tokens 220a-n). The multimodal tokens can be representative of a content item (e.g., content item 101). The content item can include one or more images, video(s), or audio content items. The concatenated tokens can include textual tokens (e.g., the plurality of textual tokens 222a-g). The textual tokens can be indicative of a text query (e.g., the text query 130).

A set of cross-attention tokens can be generated. The set of cross-attention tokens can be generated by performing cross-attention between the multimodal tokens and the textual tokens. At 704, a first weight can be assigned to the set of cross-attention tokens. A set of text self-attention tokens can be generated. The set of text self-attention tokens can be generated by performing self-attention on the textual tokens. At 706, a second weight can be assigned to the set of text self-attention tokens. The value of the first weight and the value of the second weight can be configured such that original text processing power of the large language model prior to decomposition of the attention mechanism is maintained.

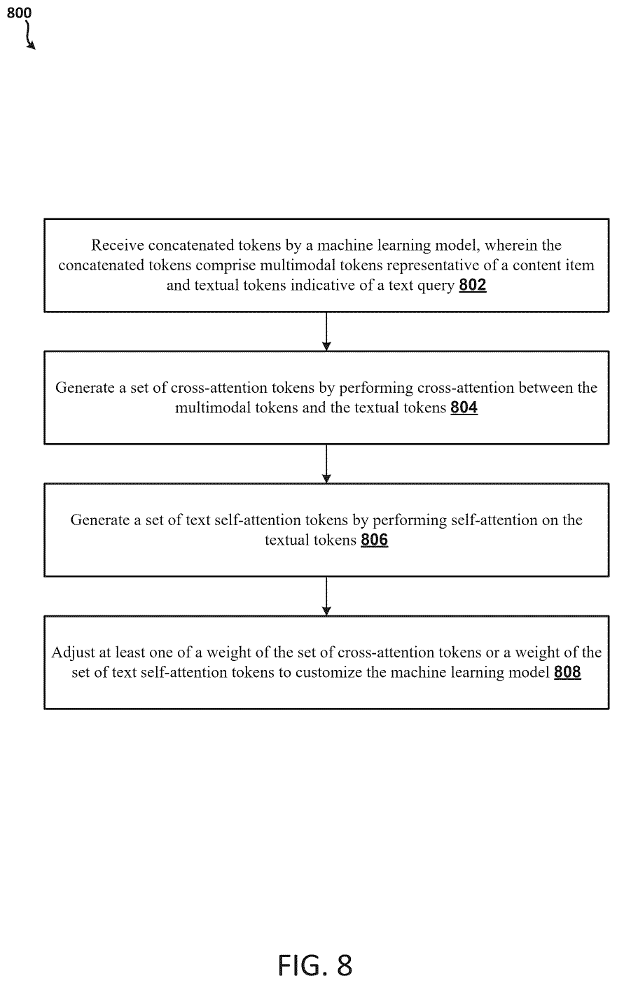

FIG. 8 shows an example process 800 for improving efficiency and flexibility of a machine learning model. Although depicted as a sequence of operations in FIG. 8, those of ordinary skill in the art will appreciate that various embodiments may add, remove, reorder, or modify the depicted operations.

At 802, concatenated tokens can be received by a machine learning model (e.g., the machine learning model 102). The concatenated tokens can include multimodal tokens (e.g., the plurality of multimodal tokens 220a-n). The multimodal tokens can be representative of a content item (e.g., content item 101). The content item can include one or more images, video(s), or audio content items. The concatenated tokens can include textual tokens (e.g., the plurality of textual tokens 222a-g). The textual tokens can be indicative of a text query (e.g., the text query 130).

At 804, a set of cross-attention tokens can be generated. The set of cross-attention tokens can be generated by performing cross-attention between the multimodal tokens and the textual tokens. At 806, a set of text self-attention tokens can be generated. The set of text self-attention tokens can be generated by performing self-attention on the textual tokens. At 808, at least one of a weight of the set of cross-attention tokens or a weight of the set of text self-attention tokens can be adjusted. Adjusting the weight of the set of cross-attention tokens and/or the weight of the set of text self-attention tokens can be performed to customize the machine learning model, thereby improving flexibility of the machine learning model.

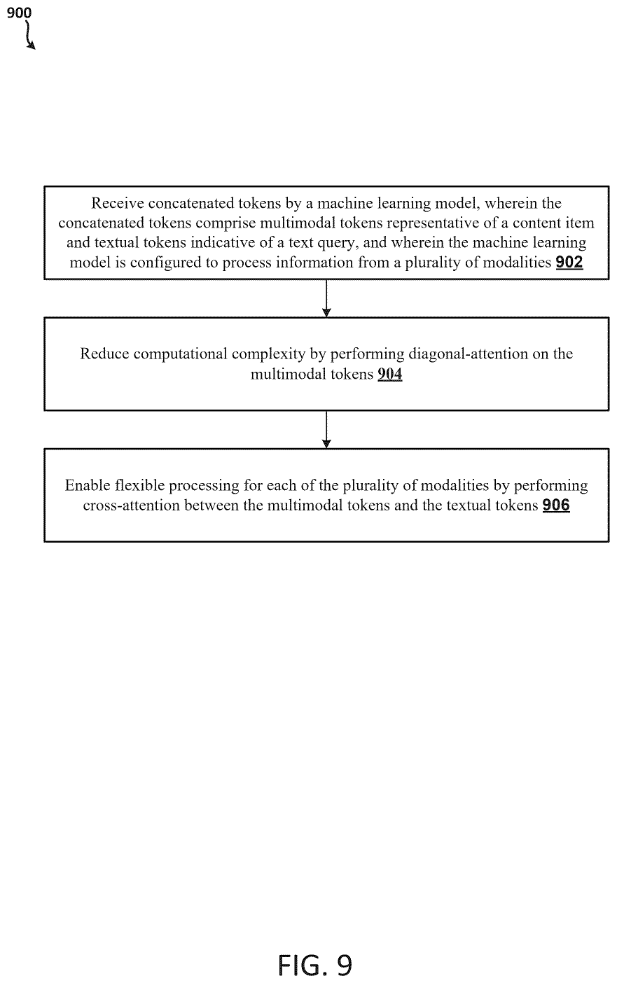

FIG. 9 shows an example process 900 for improving efficiency and flexibility of a machine learning model. Although depicted as a sequence of operations in FIG. 9, those of ordinary skill in the art will appreciate that various embodiments may add, remove, reorder, or modify the depicted operations.

At 902, concatenated tokens can be received by a machine learning model (e.g., the machine learning model 102). The concatenated tokens can include multimodal tokens (e.g., the plurality of multimodal tokens 220a-n). The multimodal tokens can be representative of a content item (e.g., content item 101). The content item can include one or more images, video(s), or audio content items. The concatenated tokens can include textual tokens (e.g., the plurality of textual tokens 222a-g). The textual tokens can be indicative of a text query (e.g., the text query 130).

Updated multimodal tokens (e.g., updated multimodal tokens 350) can be generated. The updated multimodal tokens can be used for a next layer of computation. The updated multimodal tokens can be generated by performing diagonal-attention on the multimodal tokens (e.g., the plurality of multimodal tokens 220a-n). At 904, computational complexity can be reduced by performing diagonal-attention on the multimodal tokens. Implementing the multimodal-to-multimodal diagonal-attention can reduce computational complexity, as each multimodal token among the plurality of multimodal tokens only needs to be compared to itself—and not to the textual tokens or to any other multimodal token among the plurality of multimodal tokens. At 906, flexible processing for each of the plurality of modalities can be enabled. The flexible processing for each of the plurality of modalities can be enabled by performing cross-attention between the multimodal tokens and the textual tokens.

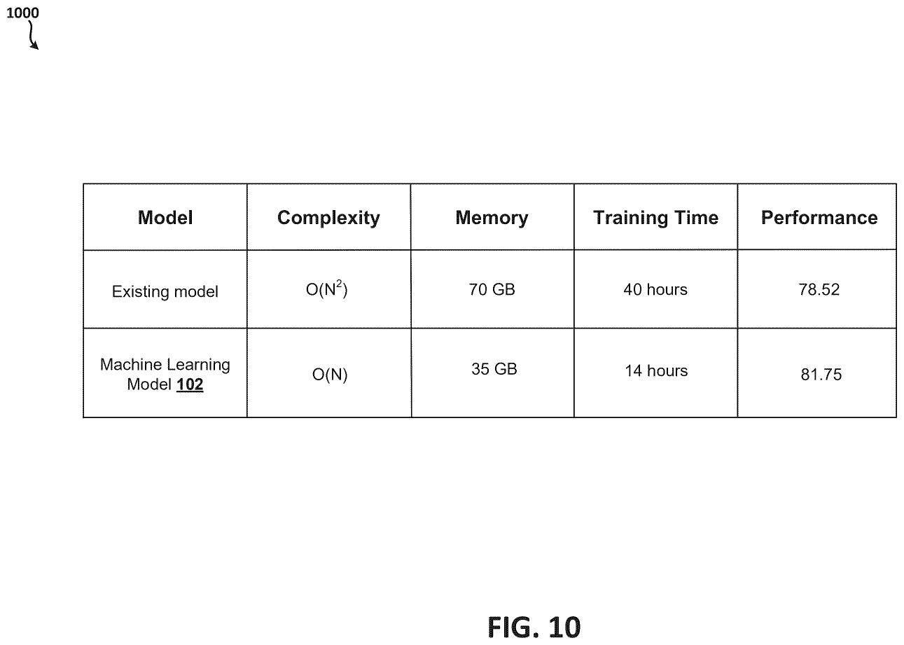

FIG. 10 show an example table 1000 illustrating comparisons between the machine learning model 102 and an existing baseline model. The existing baseline model can include a large vision language model (e.g., multi-modal large language model). As shown in the table 1000, the existing model is associated with a computational complexity of O(n²), whereas the machine learning model 102 is associated with a reduced computational complexity of O(n). The multimodal-to-multimodal diagonal-attention of the machine learning model 102 reduces the computational complexity from O(n²) to O(n). As shown in the table 1000, the existing model is associated with a larger amount of memory and a longer training time than the machine learning model 102. In particular, the existing model requires 70 gigabytes (GB) of memory for storage, whereas the machine learning model 102 only requires 35 GB of storage. Further, the existing model requires 40 hours of training time, whereas the machine learning model 102 only requires 12 hours of training time. Additionally, as shown in the last column of the table 1000, the machine learning model 102 is associated with a comparable, or even slightly better, performance as the existing model, despite having a lower computational complexity, requiring a smaller amount of storage, and a shorter training time.

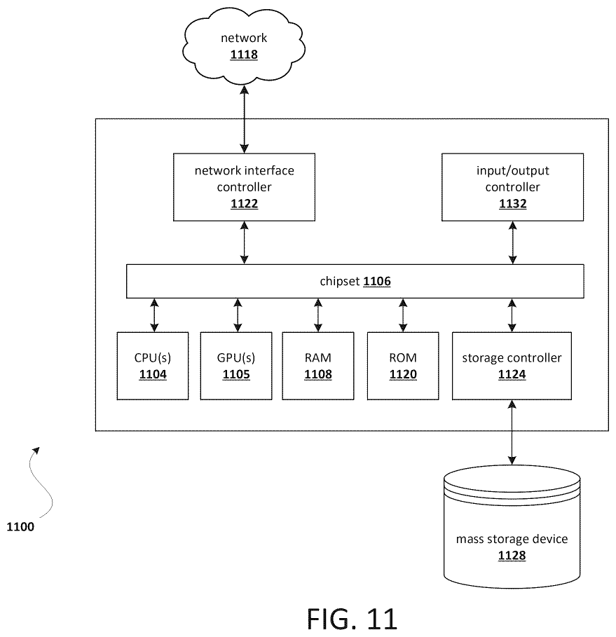

FIG. 11 illustrates a computing device that may be used in various aspects, such as the services, networks, modules, and/or devices depicted in any of FIGS. 1-3. With regard to FIGS. 1-3, any or all of the components may each be implemented by one or more instance of a computing device 1100 of FIG. 11. The computer architecture shown in FIG. 11 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1100 may include a baseboard, or “motherboard,” which is a printed circuit board to which a multitude of components or devices may be connected by way of a system bus or other electrical communication paths. One or more central processing units (CPUs) 1104 may operate in conjunction with a chipset 1106. The CPU(s) 1104 may be standard programmable processors that perform arithmetic and logical operations necessary for the operation of the computing device 1100.

The CPU(s) 1104 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1104 may be augmented with or replaced by other processing units, such as GPU(s) 1105. The GPU(s) 1105 may comprise processing units specialized for but not necessarily limited to highly parallel computations, such as graphics and other visualization-related processing.

A chipset 1106 may provide an interface between the CPU(s) 1104 and the remainder of the components and devices on the baseboard. The chipset 1106 may provide an interface to a random-access memory (RAM) 1108 used as the main memory in the computing device 1100. The chipset 1106 may further provide an interface to a computer-readable storage medium, such as a read-only memory (ROM) 1120 or non-volatile RAM (NVRAM) (not shown), for storing basic routines that may help to start up the computing device 1100 and to transfer information between the various components and devices. ROM 1120 or NVRAM may also store other software components necessary for the operation of the computing device 1100 in accordance with the aspects described herein.

The computing device 1100 may operate in a networked environment using logical connections to remote computing nodes and computer systems through local area network (LAN). The chipset 1106 may include functionality for providing network connectivity through a network interface controller (NIC) 1122, such as a gigabit Ethernet adapter. A NIC 1122 may be capable of connecting the computing device 1100 to other computing nodes over a network 1116. It should be appreciated that multiple NICs 1122 may be present in the computing device 1100, connecting the computing device to other types of networks and remote computer systems.

The computing device 1100 may be connected to a mass storage device 1128 that provides non-volatile storage for the computer. The mass storage device 1128 may store system programs, application programs, other program modules, and data, which have been described in greater detail herein. The mass storage device 1128 may be connected to the computing device 1100 through a storage controller 1124 connected to the chipset 1106. The mass storage device 1128 may consist of one or more physical storage units. The mass storage device 1128 may comprise a management component. A storage controller 1124 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1100 may store data on the mass storage device 1128 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1128 is characterized as primary or secondary storage and the like.

For example, the computing device 1100 may store information to the mass storage device 1128 by issuing instructions through a storage controller 1124 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1100 may further read information from the mass storage device 1128 by detecting the physical states or characteristics of one or more particular locations within the physical storage units.

In addition to the mass storage device 1128 described above, the computing device 1100 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1100.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1128 depicted in FIG. 11, may store an operating system utilized to control the operation of the computing device 1100. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1128 may store other system or application programs and data utilized by the computing device 1100.

The mass storage device 1128 or other computer-readable storage media may also be encoded with computer-executable instructions, which, when loaded into the computing device 1100, transforms the computing device from a general-purpose computing system into a special-purpose computer capable of implementing the aspects described herein. These computer-executable instructions transform the computing device 1100 by specifying how the CPU(s) 1104 transition between states, as described above. The computing device 1100 may have access to computer-readable storage media storing computer-executable instructions, which, when executed by the computing device 1100, may perform the methods described herein.

A computing device, such as the computing device 1100 depicted in FIG. 11, may also include an input/output controller 1132 for receiving and processing input from a number of input devices, such as a keyboard, a mouse, a touchpad, a touch screen, an electronic stylus, or other type of input device. Similarly, an input/output controller 1132 may provide output to a display, such as a computer monitor, a flat-panel display, a digital projector, a printer, a plotter, or other type of output device. It will be appreciated that the computing device 1100 may not include all of the components shown in FIG. 11, may include other components that are not explicitly shown in FIG. 11, or may utilize an architecture completely different than that shown in FIG. 11.

As described herein, a computing device may be a physical computing device, such as the computing device 1100 of FIG. 11. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of improving efficiency and flexibility of a machine learning model, comprising:
configuring a machine learning model by decomposing self-attention in the machine learning model into a plurality of attention operations, wherein the machine learning model is configured to process information from a plurality of modalities;
receiving concatenated tokens by the machine learning model, wherein the concatenated tokens comprise multimodal tokens representative of a content item and textual tokens indicative of a text query;
generating updated multimodal tokens for a next layer of computation by performing diagonal-attention on the multimodal tokens; and
generating updated textual tokens for the next layer of computation by performing self-attention on the textual tokens and performing cross-attention between the multimodal tokens and the textual tokens.

2. The method of claim 1, wherein the content item comprises an image, a video, or an audio item.

3. The method of claim 1, further comprising:
generating the updated multimodal tokens by performing the diagonal-attention based on comparing each of the multimodal tokens to itself but not to any other multimodal token among the plurality of multimodal tokens.

4. The method of claim 1, wherein the generating updated textual tokens comprises:
generating a set of cross-attention tokens by performing the cross-attention between the multimodal tokens and the textual tokens;
generating a set of text self-attention tokens by performing the self-attention on the textual tokens; and
generating the updated textual token based on the set of cross-attention tokens and the set of text self-attention tokens.

5. The method of claim 4, further comprising:
assigning a first weight to the set of cross-attention tokens; and
assigning a second weight to the set of text self-attention tokens.

6. The method of claim 5, further comprising:
adjusting at least one of the first weight or the second weight to customize the machine learning model.

7. The method of claim 1, further comprising:
reducing computational complexity by performing the diagonal-attention on the multimodal tokens; and
enabling flexible processing for each of the plurality of modalities by performing cross-attention between the multimodal tokens and the textual tokens.

8. A system of improving efficiency and flexibility of a machine learning model, comprising:
at least one processor; and
at least one memory communicatively coupled to the at least one processor and comprising computer-readable instructions that upon execution by the at least one processor cause the at least one processor to perform operations comprising:
configuring a machine learning model by decomposing self-attention in the machine learning model into a plurality of attention operations, wherein the machine learning model is configured to process information from a plurality of modalities;
receiving concatenated tokens by the machine learning model, wherein the concatenated tokens comprise multimodal tokens representative of a content item and textual tokens indicative of a text query;
generating updated multimodal tokens for a next layer of computation by performing diagonal-attention on the multimodal tokens; and
generating updated textual tokens for the next layer of computation by performing self-attention on the textual tokens and performing cross-attention between the multimodal tokens and the textual tokens.

9. The system of claim 8, wherein the content item comprises an image, a video, or an audio item.

10. The system of claim 8, the operations further comprising:
generating the updated multimodal tokens by performing the diagonal-attention based on comparing each of the multimodal tokens to itself but not to any other multimodal token among the plurality of multimodal tokens.

11. The system of claim 8, wherein the generating updated textual tokens comprises:
generating a set of cross-attention tokens by performing the cross-attention between the multimodal tokens and the textual tokens;
generating a set of text self-attention tokens by performing the self-attention on the textual tokens; and
generating the updated textual token based on the set of cross-attention tokens and the set of text self-attention tokens.

12. The system of claim 11, the operations further comprising:
assigning a first weight to the set of cross-attention tokens; and
assigning a second weight to the set of text self-attention tokens.

13. The system of claim 12, the operations further comprising:
adjusting at least one of the first weight or the second weight to customize the machine learning model.

14. The system of claim 8, the operations further comprising:
reducing computational complexity by performing the diagonal-attention on the multimodal tokens; and
enabling flexible processing for each of the plurality of modalities by performing cross-attention between the multimodal tokens and the textual tokens.

15. A non-transitory computer-readable storage medium, storing computer-readable instructions that upon execution by a processor cause the processor to implement operations comprising:
configuring a machine learning model by decomposing self-attention in the machine learning model into a plurality of attention operations, wherein the machine learning model is configured to process information from a plurality of modalities;
receiving concatenated tokens by the machine learning model, wherein the concatenated tokens comprise multimodal tokens representative of a content item and textual tokens indicative of a text query;
generating updated multimodal tokens for a next layer of computation by performing diagonal-attention on the multimodal tokens; and
generating updated textual tokens for the next layer of computation by performing self-attention on the textual tokens and performing cross-attention between the multimodal tokens and the textual tokens.

16. The non-transitory computer-readable storage medium of claim 15, wherein the content item comprises an image, a video, or an audio item.

17. The non-transitory computer-readable storage medium of claim 15, the operations further comprising:
generating the updated multimodal tokens by performing the diagonal-attention based on comparing each of the multimodal tokens to itself but not to any other multimodal token among the plurality of multimodal tokens.

18. The non-transitory computer-readable storage medium of claim 17, wherein the generating updated textual tokens comprises:
generating a set of cross-attention tokens by performing the cross-attention between the multimodal tokens and the textual tokens;
generating a set of text self-attention tokens by performing the self-attention on the textual tokens; and
generating the updated textual token based on the set of cross-attention tokens and the set of text self-attention tokens.

19. The non-transitory computer-readable storage medium of claim 18, the operations further comprising:
assigning a first weight to the set of cross-attention tokens; and
assigning a second weight to the set of text self-attention tokens.

20. The non-transitory computer-readable storage medium of claim 19, the operations further comprising:
adjusting at least one of the first weight or the second weight to customize the machine learning model.
